(19) United States
(12) Patent Application Publication
(10) Pub. No.: US 2020/0112900 A1
(43) Pub. Date: Apr. 9, 2020

(54) Enhancement Of IMS Signaling Reliability In Mobile Communications

(71) Applicant: MediaTek Inc., Hsinchu City (TW)

(72) Inventors: Chien-Chun Huang-Fu, Hsinchu City (TW); Ming-Cong Sun, Hsinchu City (TW); Wei-Chiang Peng, Hsinchu City (TW)

(21) Appl. No.: 16/593,487

(22) Filed: Oct. 4, 2019

Related U.S. Application Data
(60) Provisional application No. 62/741,653, filed on Oct. 5, 2018.

(51) Int. Cl. H04W 36/12; H04L 29/08; H04L 29/06; H04L 5/00; H04L 1/16; H04W 36/14

(52) U.S. Cl. CPC H04W 36/12; H04L 69/324; H04L 69/329; H04W 36/14; H04L 65/1016; H04L 5/0055; H04L 1/16; H04L 65/1006

(57) ABSTRACT

Various examples and schemes pertaining to enhancement of Internet Protocol (IP) Multimedia Subsystem (IMS) signaling reliability in mobile communications are described. A processor of an apparatus receives, at a layer 2 of a New Radio (NR) protocol stack, a packet for a specific type of signaling from an application layer of the NR protocol stack. The processor identifies, at the layer 2, one data radio bear (DRB) to be used for delivery of the packet. The processor then activates a reliability enhancement mechanism for the identified DRB such that a retransmission of the packet via the identified DRB is coordinated at the layer 2 or a layer above the layer 2.

### CROSS REFERENCE TO RELATED PATENT APPLICATION(S)

The present disclosure is part of a non-provisional application claiming the priority benefit of U.S. Patent Application No. 62/741,653, filed on 5 Oct. 2018, the content of which being incorporated by reference in its entirety.

### TECHNICAL FIELD

The present disclosure is generally related to mobile communications and, more particularly, to enhancement of Internet Protocol (IP) Multimedia Subsystem (IMS) signaling reliability in mobile communications.

### BACKGROUND

Unless otherwise indicated herein, approaches described in this section are not prior art to the claims listed below and are not admitted as prior art by inclusion in this section.

In a 5th Generation (5G) system, voice services can be realized by 4th Generation (4G) Evolved Packet System (EPS) fallback. However, call setup latency and call drop rate might be high due to loss of Session Initiation Protocol (SIP) signaling message(s) during a 5G-to-4G inter-system change. Currently, the only mechanism to ensure a voice call setup is to retransmit lost message(s) triggered by an upper layer such as the application layer (e.g., by SIP) or the transport layer (e.g., by Transmission Control Protocol (TCP)).

In the current design, a SIP signaling message is transmitted by radio link control (RLC) in the acknowledge mode (AM). However, once a handover has occurred while RLC data protocol data unit (PDU) is not acknowledged during the inter-system change, the same packet is not retransmitted. The retransmission mechanism by the application layer might be involved, and usually IMS signaling needs to take extra 2 seconds for User Datagram Protocol (UDP) and 3 seconds for TCP. Such delay would be excessive and could result in call drop. Therefore, this issue needs to be addressed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method, implementable in a processor in which operations of a New Radio (NR) protocol stack are executed for NR mobile communications, may involve the processor, at a layer 2 of the NR protocol stack, receiving a packet for a specific type of signaling from an application layer of the NR protocol stack. The method may also involve the processor, at the layer 2, identifying one data radio bear (DRB) to be used for delivery of the packet. The method may further involve the processor activating a reliability enhancement mechanism for the identified DRB such that a retransmission of the packet via the identified DRB is coordinated at the layer 2 or a layer above the layer 2.

In one aspect, a method, implementable in a processor in which operations of an NR protocol stack are executed for NR mobile communications, may involve the processor, at a layer 2 of the NR protocol stack, receiving a package for a specific type of signaling from an application layer of the NR protocol stack. The method may also involve the processor identifying, at the layer 2, one DRB to be used for delivery of the packet. The method may then involve the processor transmitting, via the NR protocol stack, the packet via the identified DRB in an acknowledgement mode (AM). The method may further involve the processor monitoring whether an acknowledgement (ACK) is received with respect to the transmitting of the packet via the identified DRB. The method may additionally involve the processor coordinating a retransmission of the packet responsive to no ACK being received.

In one aspect, an apparatus may include a transceiver and a processor coupled to the transceiver. The transceiver may be configured to wirelessly communicate with a network node of a wireless network. The processor may be configured to receive, at a layer 2 of an NR protocol stack, a packet for a specific type of signaling from an application layer of the NR protocol stack. The processor may be also configured to identify, at the layer 2, one DRB to be used for delivery of the packet. The processor may be further configured to activate a reliability enhancement mechanism for the identified DRB such that a retransmission of the packet via the identified DRB is coordinated at the layer 2 or a layer above the layer 2.

It is noteworthy that, although description provided herein may be in the context of certain radio access technologies, networks and network topologies such as 5G and NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, narrowband (NB), narrowband Internet of Things (NB-IoT), and any future-developed networks and technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of example scenarios each in accordance with an implementation of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancement of IMS signaling reliability in mobile communications. According to the present disclosure, a number of possible solutions may be implemented separately or jointly. That is, although these possible solutions may be described below separately, two or more of these possible solutions may be implemented in one combination or another.

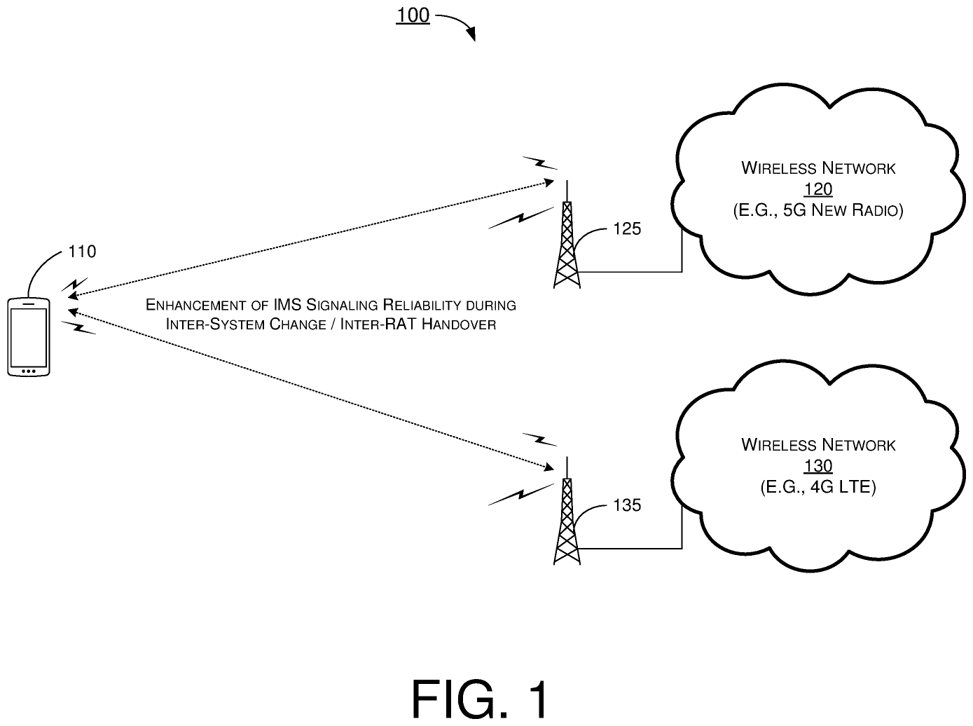

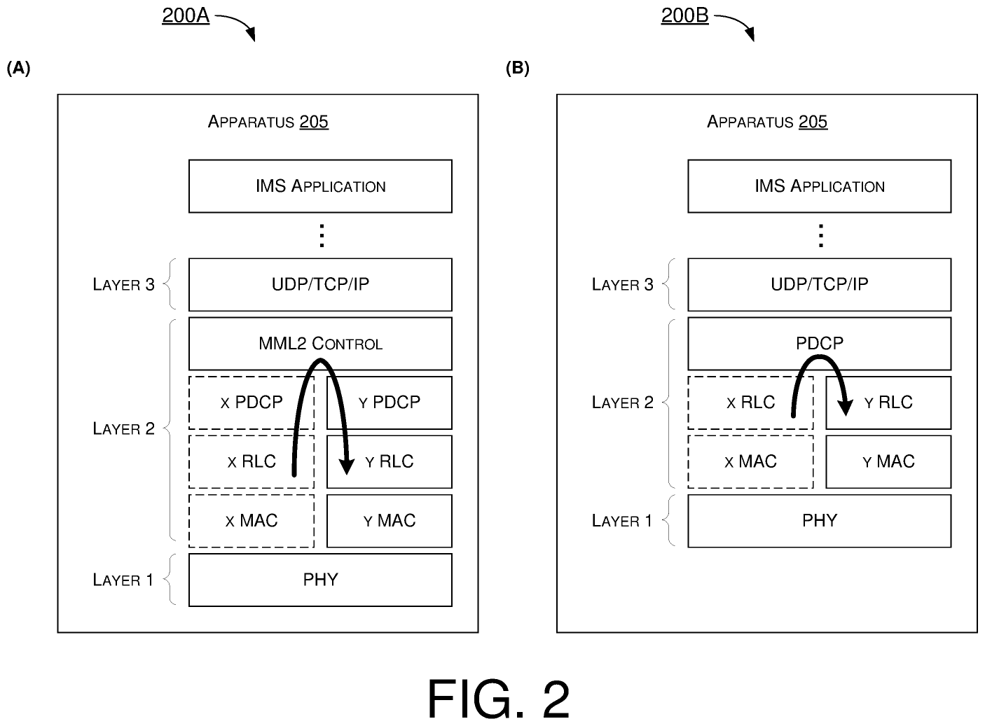

FIG. 1 illustrates an example network environment 100 in which various solutions and schemes in accordance with the present disclosure may be implemented. FIG. 2 illustrates example scenarios 200A and 200B each in accordance with an implementation of the present disclosure. Each of scenarios 200A and 200B may be implemented in network environment 100. The following description of various proposed schemes is provided with reference to FIG. 1 and FIG. 2.

Referring to FIG. 1, network environment 100 may involve a UE 110, a first wireless network 120 (e.g., a 5G NR mobile network) and a second wireless network 130 (e.g., a 4G LTE mobile network). Initially, UE 110 may be in wireless communication with either of first wireless network 120 via a first base station 125 (e.g., a gNB or a transmit-receive point (TRP)) or second wireless network 130 via a second base station 135 (e.g., an eNB). In network environment 100, UE 110 may implement various schemes pertaining to enhancement of IMS signaling reliability in mobile communications in accordance with the present disclosure. For instance, due to an inter-system change or inter-radio access technology (inter-RAT) change, UE 110 may switch from being connected to one of first wireless network 120 and second wireless network 130 to being connected the other of first wireless network 120 and second wireless network 130. The follow description of various solutions and schemes in accordance with the present disclosure is provided with reference to FIG. 1 and FIG. 2.

Part (A) of FIG. 2 shows scenario 200A, and part (B) of FIG. 2 shows scenario 200B. Each of scenarios 200A and 200B may involve an apparatus 205 in which operations of an NR protocol stack may be executed under various proposed scheme in accordance with the present disclosure. Apparatus 205 may be implemented in or as a part of UE 110 (e.g., as a system on chip (SoC) or as a processor and a communication device such as a transceiver). In each of scenarios 200A and 200B, a higher-layer application (e.g., an IMS application) may send one or more packets of a specific type of signaling (e.g., SIP signaling for a mobile-originated voice call) to layer 2 of the NR protocol stack for handling. As SIP signaling for voice calls are generally latency-sensitive and hence high-priority, apparatus 205 may, at layer 2, handle the SIP signaling in acknowledgement mode (AM). In each of scenarios 200A and 200B, layer 2 may identify one DRB from a plurality of DRBs, which are established between UE 110 and either of first wireless network 120 and third wireless network 130, as the DRB used for delivery of the one or more packets for SIP signaling. Accordingly, under a proposed scheme in accordance with the present disclosure, apparatus 205 may activate, at layer 2, a reliability enhancement mechanism for the identified DRB to thereby enhance reliability for the SIP signaling triggered by the IMS application.

Under the proposed scheme, apparatus 205 may activate the reliability enhancement mechanism by detecting, at layer 2, an occurrence of a predefined event with respect to the identified DRB and, in response to detecting the predefined event, coordinating, at layer 2, a retransmission of the one or more packets via the identified DRB. The occurrence of a predefined event may be an inter-system change or inter-RAT handover. For instance, apparatus 205 may, at layer 1 (e.g., a physical (PHY) layer) of the NR protocol stack, transmit the one or more packets of SIP signaling via the identified DRB in an acknowledgement mode. Then, apparatus 205 may, at layer 2, detect whether an acknowledgement (ACK) is received with respect to the transmitting of the one or more packets via the identified DRB. When no ACK is received, apparatus 205 may, at layer 2, determine that the predefined event has occurred.

In scenario 200A, the coordination of the retransmission of the one or more packets of SIP signaling may involve a multi-mode layer 2 (MML2), as a sublayer within layer 2 of the NR protocol stack, coordinating the retransmission. As shown in part (A) of FIG. 2, MML2 may be above a Packet Data Convergence Control (PDCP) layer which is another sublayer within layer 2 of the NR protocol stack. Also, as shown in part (A) of FIG. 2, the PDCP layer may be above a Radio Link Control (RLC) layer, which is yet another sublayer within layer 2 of the NR protocol stack. In scenario 200A, in layer 2, the sublayers PDCP and RLC may be associated with a source RAT (shown as x PDCP and x RLC for the source RAT) and a target RAT (shown as y PDCP and y RLC for the target RAT). Thus, in scenario 200A, the layer 2 entity that coordinates the retransmission of the SIP signaling packet(s) upon detection of no ACK being received may be a sublayer (e.g., MML2) over the PDCP.

In scenario 200B, the coordination of the retransmission of the one or more packets of SIP signaling may involve the PDCP layer, which is a sublayer within layer 2 of the NR protocol stack, coordinating the retransmission. As shown in part (B) of FIG. 2, the PDCP layer may be shared by a source RAT and a target RAT with respect to the retransmission of the one or more packets. In scenario 200B, in layer 2, the sublayer RLC may be associated with the source RAT (shown as x RLC for the source RAT) and the target RAT (shown as y RLC for the target RAT). Thus, in scenario 200B, the layer 2 entity that coordinates the retransmission of the SIP signaling packet(s) upon detection of no ACK being received may be in the PDCP.

Under the proposed scheme, apparatus 205 may coordinate the retransmission of the one or more packets by retrieving, at layer 2, the unacknowledged SIP signaling packet(s) from the source RAT. Additionally, apparatus 205 may, at layer 2, identify time-frequency resources at the target RAT. Moreover, apparatus 205 may, at layer 2, initiate a transmission of a PDCP service data unit (SDU) for the one or more packets on the allocated resources.

It is noteworthy that, although examples described herein may be in the context of transmission and retransmission of packets for SIP signaling for an IMS application, the various proposed schemes in accordance with the present disclosure may be applied to different contexts and scenarios other than SIP signaling and/or IMS. Thus, the scope of various proposed schemes in accordance with the present disclosure is not limited merely to the examples described herein.

### Illustrative Implementations

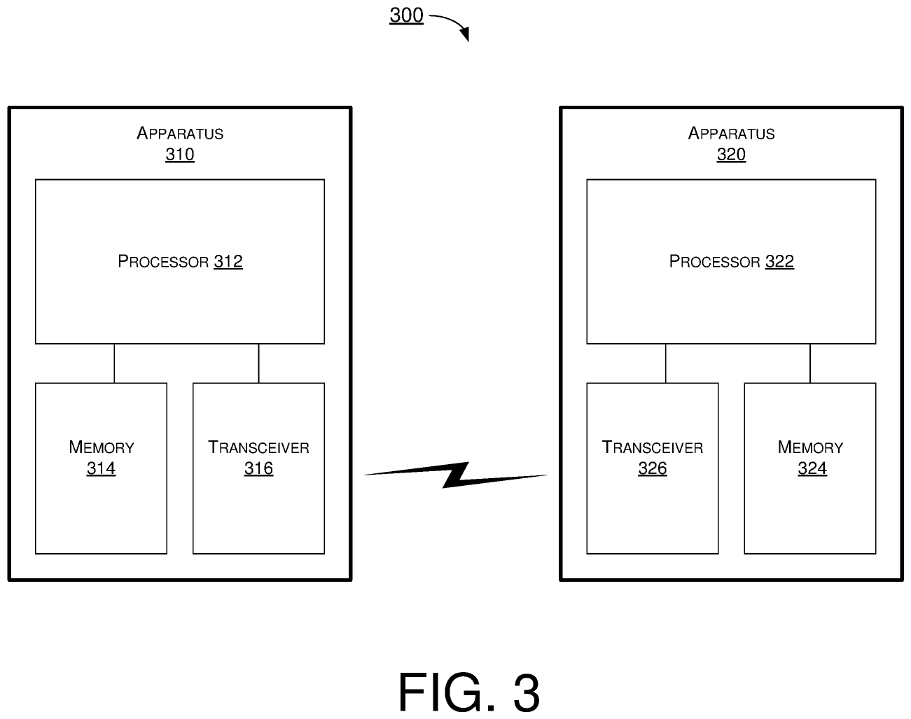

FIG. 3 illustrates an example communication system 300 having an example apparatus 310 and an example apparatus 320 in accordance with an implementation of the present disclosure. Each of apparatus 310 and apparatus 320 may perform various functions to implement schemes, techniques, processes and methods described herein pertaining to enhancement of IMS signaling reliability in mobile communications, including various schemes described above as well as process 400 described below.

Each of apparatus 310 and apparatus 320 may be a part of an electronic apparatus, which may be a UE such as a portable or mobile apparatus, a wearable apparatus, a wireless communication apparatus or a computing apparatus. For instance, each of apparatus 310 and apparatus 320 may be implemented in a smartphone, a smartwatch, a personal digital assistant, a digital camera, or a computing equipment such as a tablet computer, a laptop computer or a notebook computer. Each of apparatus 310 and apparatus 320 may also be a part of a machine type apparatus, which may be an IoT or NB-IoT apparatus such as an immobile or a stationary apparatus, a home apparatus, a wire communication apparatus or a computing apparatus. For instance, each of apparatus 310 and apparatus 320 may be implemented in a smart thermostat, a smart fridge, a smart door lock, a wireless speaker or a home control center. Alternatively, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 310 and apparatus 320 may include at least some of those components shown in FIG. 3 such as a processor 312 and a processor 322, respectively. Each of apparatus 310 and apparatus 320 may further include one or more other components not pertinent to the proposed scheme of the present disclosure (e.g., internal power supply, display device and/or user interface device), and, thus, such component(s) of each of apparatus 310 and apparatus 320 are neither shown in FIG. 3 nor described below in the interest of simplicity and brevity.

In some implementations, at least one of apparatus 310 and apparatus 320 may be a part of an electronic apparatus, which may be a network node or base station (e.g., eNB, gNB or TRP), a small cell, a router or a gateway. For instance, at least one of apparatus 310 and apparatus 320 may be implemented in an eNodeB in an LTE, LTE-Advanced or LTE-Advanced Pro network or in a gNB in a 5G, NR, IoT or NB-IoT network. Alternatively, at least one of apparatus 310 and apparatus 320 may be implemented in the form of one or more IC chips such as, for example and without limitation, one or more single-core processors, one or more multi-core processors, or one or more CISC or RISC processors.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including enhancement of IMS signaling reliability in mobile communications in accordance with various implementations of the present disclosure.

In some implementations, apparatus 310 may also include a transceiver 316, as a communication device, coupled to processor 312 and capable of wirelessly transmitting and receiving data. In some implementations, apparatus 310 may further include a memory 314 coupled to processor 312 and capable of being accessed by processor 312 and storing data therein. In some implementations, apparatus 320 may also include a transceiver 326, as a communication device, coupled to processor 322 and capable of wirelessly transmitting and receiving data. In some implementations, apparatus 320 may further include a memory 324 coupled to processor 322 and capable of being accessed by processor 322 and storing data therein. Accordingly, apparatus 310 and apparatus 320 may wirelessly communicate with each other via transceiver 316 and transceiver 326, respectively.

To aid better understanding, the following description of the operations, functionalities and capabilities of each of apparatus 310 and apparatus 320 is provided in the context of an NR or NB-IoT communication environment in which apparatus 310 is implemented in or as a wireless communication device, a communication apparatus or a UE and apparatus 320 is implemented in or as a network node (e.g., base station 125 or base station 135) of a wireless network (e.g., first wireless network 120 or second wireless network 130).

In one aspect of enhancement of signaling reliability in mobile communications in accordance with the present disclosure, processor 312 of apparatus 310 as a UE (e.g., UE 110) may receive, at layer 2 of the NR protocol stack, a packet for a specific type of signaling from an application layer of the NR protocol stack. Additionally, processor 312 may identify, at layer 2, one DRB to be used for delivery of the packet. Moreover, processor 312 may activate a reliability enhancement mechanism for the identified DRB such that a retransmission of the packet via the identified DRB is coordinated at layer 2 or a layer configured above layer 2.

In some implementations, in activating the reliability enhancement mechanism for the identified DRB such the retransmission of the packet via the identified DRB is coordinated at the layer 2 or a layer configured above layer 2, processor 312 may perform certain operations. For instance, processor 312 may detect an occurrence of a predefined event with respect to the identified DRB. Moreover, processor 312 may coordinate the retransmission of the packet via the identified DRB responsive to the detecting.

In some implementations (e.g., as in scenario 200A) of the present disclosure, processor 312 may coordinate the retransmission of the packet at a sublayer configured in the NR protocol stack. This configured sublayer MML2 (multi-mode L2) may be defined as another sublayer within layer 2, above a PDCP layer; or, this configured sublayer MML2 may be defined as another layer not included in layer 2. Alternatively (e.g., as in scenario 200B) processor 312 may coordinate retransmission of the packet at the PDCP layer which is a sublayer within layer 2 of the NR protocol stack, with the PDCP layer being shared by a source RAT and a target RAT with respect to the retransmission of the packet.

In some implementations, the predefined event may include an inter-system change or an inter-RAT handover.

In some implementations, in detecting the occurrence of the predefined event with respect to the identified DRB, processor 312 may perform certain operations. For instance, processor 312 may transmit, via the NR protocol stack, the packet via the identified DRB in an acknowledgement mode (AM). Moreover, processor 312 may detect that no ACK is received with respect to the transmitting of the packet via the identified DRB.

In some implementations, in coordinating the retransmission of the packet, processor 312 may perform certain operations. For instance, processor 312 may retrieve, at layer 2, the packet from a source RAT. Additionally, processor 312 may initiate, at layer 2, a transmission of a PDCP SDU for the packet at a target RAT. It is to be noted that, processor 312 may allocate resources at the target RAT.

In some implementations, the packet for the specific type of signaling may include a SIP packet for voice signaling. Moreover, in receiving the packet from the application layer, processor 312 may receive, at layer 2, the packet from an IMS application at the application layer of the NR protocol stack.

In another aspect of enhancement of IMS signaling reliability in mobile communications in accordance with the present disclosure, processor 312 of apparatus 310 as a UE (e.g., UE 110) may receive, at layer 2 of the NR protocol stack, a packet for a specific type of signaling from an application layer of the NR protocol stack (e.g., a SIP package from an IMS application). Additionally, processor 312 may identify, at layer 2, one DRB to be used for delivery of the packet. Moreover, processor 312 may transmit, via the NR protocol stack, the packet via the identified DRB in an acknowledgement mode. Furthermore, processor 312 may monitor whether an ACK is received with respect to the transmitting of the packet via the identified DRB. Moreover, processor 312 may coordinate a retransmission of the packet responsive to no ACK being received.

In some implementations (e.g., as in scenario 200A), processor 312 may coordinate the retransmission of the packet at a sublayer configured above a PDCP layer of the NR protocol stack. Alternatively (e.g., as in scenario 200B), in coordinating the retransmission of the packet, processor 312 may coordinate retransmission of the packet at the PDCP layer which is a sublayer within layer 2 of the NR protocol stack, with the PDCP layer being shared by a source RAT and a target RAT with respect to the retransmission of the packet.

In some implementations, processor 312 may perform certain operations. For instance, processor 312 may retrieve the SIP packet from a source RAT. Moreover, processor 312 may initiate a transmission of a PDCP SDU for the packet at a target RAT.

### Illustrative Processes

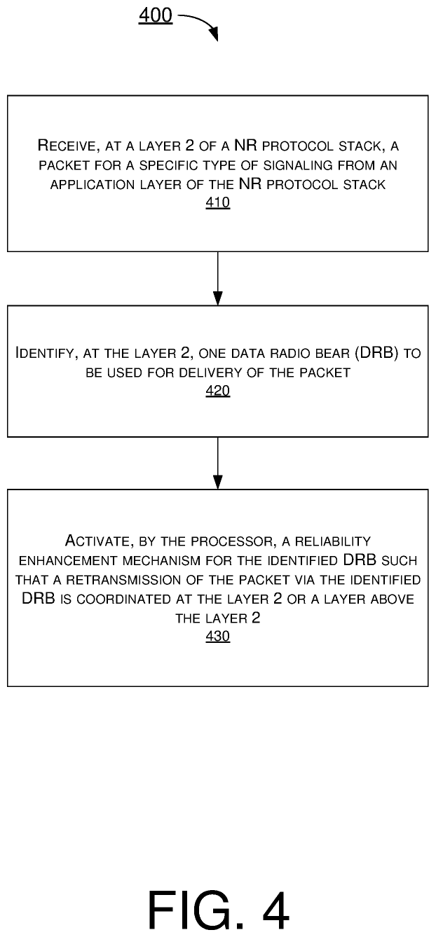

FIG. 4 illustrates an example process 400 in accordance with an implementation of the present disclosure. Process 400 may be an example implementation of the proposed schemes described above with respect to enhancement of IMS signaling reliability in mobile communications in accordance with the present disclosure. Process 400 may represent an aspect of implementation of features of apparatus 310 and apparatus 320. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may also be repeated partially or entirely. Process 400 may be implemented by apparatus 310, apparatus 320 and/or any suitable wireless communication device, UE, base station or machine type devices. Solely for illustrative purposes and without limitation, process 400 is described below in the context of apparatus 310 as a UE (e.g., UE 110) and apparatus 320 as a network node (e.g., base station 125 or base station 135) of a wireless network (e.g., first wireless network 120 or second wireless network 130). Process 400 may begin at block 410.

At 410, process 400 may involve processor 312 of apparatus 310 as a UE (e.g., UE 110) receiving, at layer 2 of the NR protocol stack, a packet for a specific type of signaling from an application layer of the NR protocol stack. Process 400 may proceed from 410 to 420.

At 420, process 400 may involve processor 312 identifying, at layer 2, one DRB to be used for delivery of the packet. Process 400 may proceed from 420 to 430.

At 430, process 400 may involve processor 312 activating a reliability enhancement mechanism for the identified DRB such that a retransmission of the packet via the identified DRB is coordinated at layer 2 or a layer above the layer 2.

In some implementations, in activating the reliability enhancement mechanism for the identified DRB such the retransmission of the packet via the identified DRB is coordinated, process 400 may involve processor 312 performing certain operations. For instance, process 400 may involve processor 312 detecting an occurrence of a predefined event with respect to the identified DRB. Moreover, process 400 may involve processor 312 coordinating, at layer 2, the retransmission of the packet via the identified DRB responsive to the detecting.

In some implementations (e.g., as in scenario 200A), in coordinating the retransmission of the packet, process 400 may involve processor 312 coordinating the retransmission of the packet at a sublayer configured above a PDCP layer of the NR protocol stack. Alternatively (e.g., as in scenario 200B), in coordinating the retransmission of the packet, process 400 may involve processor 312 coordinating retransmission of the packet at the PDCP layer which is a sublayer within layer 2 of the NR protocol stack, with the PDCP layer being shared by a source RAT and a target RAT with respect to the retransmission of the packet.

In some implementations, the predefined event may include an inter-system change or an inter-RAT handover.

In some implementations, in detecting the occurrence of the predefined event with respect to the identified DRB, process 400 may involve processor 312 performing certain operations. For instance, process 400 may involve processor 312 transmitting, via the NR protocol stack, the packet via the identified DRB in an acknowledgement mode (AM). Moreover, process 400 may involve processor 312 detecting, at layer 2, that no ACK is received with respect to the transmitting of the packet via the identified DRB.

In some implementations, in coordinating the retransmission of the packet, process 400 may involve processor 312 performing certain operations. For instance, process 400 may involve processor 312 retrieving, at layer 2, the packet from a source RAT. Additionally, process 400 may involve processor 312 initiating, at layer 2, a transmission of a PDCP SDU for the packet at a target RAT.

In some implementations, the packet for the specific type of signaling may include a SIP packet for voice signaling. Moreover, in receiving the packet from the application layer, process 400 may involve processor 312 receiving, at layer 2, the packet from an IMS application at the application layer of the NR protocol stack.

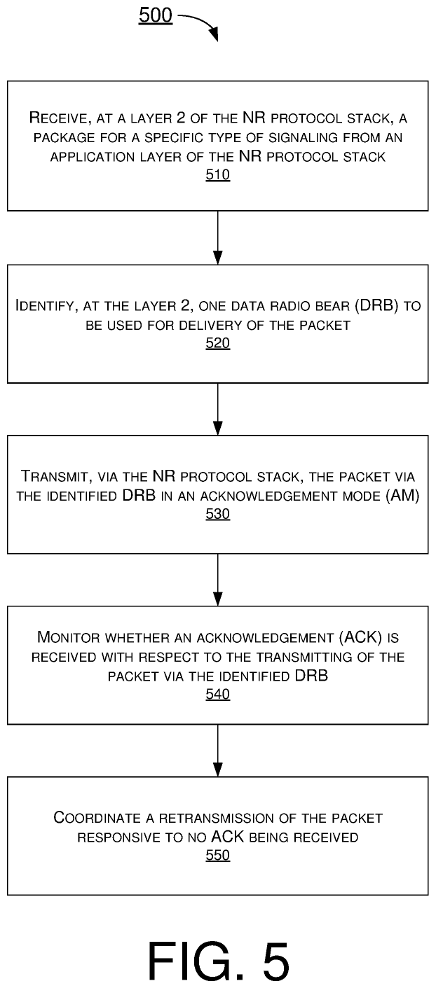

FIG. 5 illustrates an example process 500 in accordance with an implementation of the present disclosure. Process 500 may be an example implementation of the proposed schemes described above with respect to enhancement of IMS signaling reliability in mobile communications in accordance with the present disclosure. Process 500 may represent an aspect of implementation of features of apparatus 310 and apparatus 320. Process 500 may include one or more operations, actions, or functions as illustrated by one or more of blocks 510, 520, 530, 540 and 550. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may also be repeated partially or entirely. Process 500 may be implemented by apparatus 310, apparatus 320 and/or any suitable wireless communication device, UE, base station or machine type devices. Solely for illustrative purposes and without limitation, process 500 is described below in the context of apparatus 310 as a UE (e.g., UE 110) and apparatus 320 as a network node (e.g., base station 125 or base station 135) of a wireless network (e.g., first wireless network 120 or second wireless network 130). Process 500 may begin at block 510.

At 510, process 500 may involve processor 312 of apparatus 310 as a UE (e.g., UE 110) receiving, at layer 2 of the NR protocol stack, a packet for a specific type of signaling from an application layer of the NR protocol stack (e.g., a SIP package from an IMS application). Process 500 may proceed from 510 to 520.

At 520, process 500 may involve processor 312 identifying, at layer 2, one DRB to be used for delivery of the packet. Process 500 may proceed from 520 to 530.

At 530, process 500 may involve processor 312 transmitting, via the NR protocol stack, the packet via the identified DRB in an acknowledgement mode. Process 500 may proceed from 530 to 540.

At 540, process 500 may involve processor 312 monitoring whether an ACK is received with respect to the transmitting of the packet via the identified DRB. Process 500 may proceed from 540 to 550.

At 550, process 500 may involve processor 312 coordinating a retransmission of the packet responsive to no ACK being received.

In some implementations (e.g., as in scenario 200A), in coordinating the retransmission of the packet, process 500 may involve processor 312 coordinating the retransmission of the packet at a sublayer configured above a PDCP layer of the NR protocol stack. Alternatively (e.g., as in scenario 200B), in coordinating the retransmission of the packet, process 500 may involve processor 312 coordinating retransmission of the packet at the PDCP layer which is a sublayer within layer 2 of the NR protocol stack, with the PDCP layer being shared by a source RAT and a target RAT with respect to the retransmission of the packet.

In some implementations, in coordinating the retransmission of the packet, process 500 may involve processor 312 performing certain operations. For instance, process 500 may involve processor 312 retrieving, at layer 2, the packet from a source RAT. Furthermore, process 500 may involve processor 312 initiating, at layer 2, a transmission of a PDCP SDU for the packet at a target RAT.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method implemented in a processor in which operations of a New Radio (NR) protocol stack are executed for NR mobile communications, comprising:
receiving, at a layer 2 of the NR protocol stack, a packet for a specific type of signaling from an application layer of the NR protocol stack;
identifying, at the layer 2, one data radio bear (DRB) to be used for delivery of the packet; and
activating, by the processor, a reliability enhancement mechanism for the identified DRB such that a retransmission of the packet via the identified DRB is coordinated at the layer 2 or a layer above the layer 2.

2. The method of claim 1, wherein the activating of the reliability enhancement mechanism for the identified DRB such the retransmission of the packet via the identified DRB is coordinated comprises:
detecting an occurrence of a predefined event with respect to the identified DRB; and
coordinating the retransmission of the packet via the identified DRB responsive to the detecting.

3. The method of claim 2, wherein the coordinating of the retransmission of the packet comprises coordinating the retransmission of the packet at a sublayer configured above a Packet Data Convergence Control (PDCP) layer of the NR protocol stack.

4. The method of claim 2, wherein the coordinating of the retransmission of the packet comprises coordinating the retransmission of the packet at a Packet Data Convergence Control (PDCP) layer as a sublayer within the layer 2 of the NR protocol stack, and wherein the PDCP layer is shared by a source radio access technology (RAT) and a target RAT with respect to the retransmission of the packet.

5. The method of claim 2, wherein the predefined event comprises an inter-system change or an inter-radio access technology (inter-RAT) handover.

6. The method of claim 2, wherein detecting of the occurrence of the predefined event with respect to the identified DRB comprises:
transmitting, via the NR protocol stack, the packet via the identified DRB in an acknowledgement mode (AM); and
detecting, at the layer 2, that no acknowledgement (ACK) is received with respect to the transmitting of the packet via the identified DRB.

7. The method of claim 2, wherein the coordinating of the retransmission of the packet comprises:
retrieving, at the layer 2, the packet from a source radio access technology (RAT); and
initiating, at the layer 2, a transmission of a Packet Data Convergence Control (PDCP) service data unit (SDU) for the packet at a target RAT.

8. The method of claim 1, wherein the packet for the specific type of signaling comprises a Session Initiation Protocol (SIP) packet for voice signaling, and wherein the receiving of the packet from the application layer comprises receiving the packet from an Internet Protocol (IP) Multimedia Subsystem (IMS) application.

9. A method implemented in a processor in which operations of a New Radio (NR) protocol stack are executed for NR mobile communications, comprising:
receiving, at a layer 2 of the NR protocol stack, a packet for a specific type of signaling from an application layer of the NR protocol stack
identifying, at the layer 2, one data radio bear (DRB) to be used for delivery of the packet;
transmitting, via the NR protocol stack, the packet via the identified DRB in an acknowledgement mode (AM);
monitoring whether an acknowledgement (ACK) is received with respect to the transmitting of the packet via the identified DRB; and
coordinating a retransmission of the packet responsive to no ACK being received.

10. The method of claim 9, wherein the coordinating of the retransmission of the packet comprises coordinating the retransmission of the packet at a sublayer configured above a Packet Data Convergence Control (PDCP) layer of the NR protocol stack.

11. The method of claim 9, wherein the coordinating of the retransmission of the SIP packet comprises coordinating the retransmission of the packet at a Packet Data Convergence Control (PDCP) layer as a sublayer within the layer 2 of the NR protocol stack, and wherein the PDCP layer is shared by a source radio access technology (RAT) and a target RAT with respect to the retransmission of the packet.

12. The method of claim 9, wherein the coordinating of the retransmission of the packet comprises:
retrieving, at the layer 2, the SIP packet from a source radio access technology (RAT); and
initiating, at the layer 2, a transmission of a Packet Data Convergence Control (PDCP) service data unit (SDU) for the packet at a target RAT.

13. An apparatus, comprising:
a transceiver configured to wirelessly communicate with a network node of a wireless network; and
a processor coupled to the transceiver and configured to perform operations comprising:
receiving, at a layer 2 of a New Radio (NR) protocol stack, a packet for a specific type of signaling from an application layer of the NR protocol stack;
identifying, at the layer 2, one data radio bear (DRB) to be used for delivery of the packet; and
activating a reliability enhancement mechanism for the identified DRB such that a retransmission of the packet via the identified DRB is coordinated at the layer 2 or a layer above the layer 2.

14. The apparatus of claim 13, wherein, in activating the reliability enhancement mechanism for the identified DRB such the retransmission of the packet via the identified DRB is coordinated, the processor is configured to perform operations comprising:
detecting an occurrence of a predefined event with respect to the identified DRB; and
coordinating the retransmission of the packet via the identified DRB responsive to the detecting.

15. The apparatus of claim 14, wherein, in coordinating the retransmission of the packet, the processor is configured to coordinate the retransmission of the packet at a sublayer configured above a Packet Data Convergence Control (PDCP) layer of the NR protocol stack.

16. The apparatus of claim 14, wherein, in coordinating the retransmission of the packet, the processor is configured to coordinate the retransmission of the packet at a Packet Data Convergence Control (PDCP) layer as a sublayer within the layer 2 of the NR protocol stack, and wherein the PDCP layer is shared by a source radio access technology (RAT) and a target RAT with respect to the retransmission of the packet.

17. The apparatus of claim 14, wherein the predefined event comprises an inter-system change or an inter-radio access technology (inter-RAT) handover.

18. The apparatus of claim 14, wherein, in detecting the occurrence of the predefined event with respect to the identified DRB, the processor is configured to perform operations comprising:
transmitting, via the NR protocol stack, the packet via the identified DRB in an acknowledgement mode (AM); and
detecting that no acknowledgement (ACK) is received with respect to the transmitting of the packet via the identified DRB.

19. The apparatus of claim 14, wherein, in coordinating the retransmission of the packet, the processor is configured to perform operations comprising:
retrieving, at the layer 2, the packet from a source radio access technology (RAT); and
initiating, at the layer 2, a transmission of a Packet Data Convergence Control (PDCP) service data unit (SDU) for the packet at a target RAT.

20. The apparatus of claim 13, wherein the packet for the specific type of signaling comprises a Session Initiation Protocol (SIP) packet for voice signaling, and wherein the packet is received from an Internet Protocol (IP) Multimedia Subsystem (IMS) application.
